(19) United States
(12) Patent Application Publication
(10) Pub. No.: US 2025/0011954 A1
(43) Pub. Date: Jan. 9, 2025

(54) OPERATION OF AN ELECTROLYTIC CELL OR SYSTEM AT INTERMEDIATE OXYGEN PRESSURE

(71) Applicant: ELECTRIC HYDROGEN CO., Natick, MA (US)

(72) Inventors: Jigish TRIVEDI, Pleasanton, CA (US); David EAGLESHAM, Lexington, MA (US); Danielle GOBRON, Arlington, MA (US); Jeffrey Dean GLANDT, Vancouver (CA); Curt C. EBNER, Redwood City, CA (US); Adam LIBERT, Pacifica, CA (US)

(21) Appl. No.: 18/687,207

(22) PCT Filed: Dec. 16, 2022
(86) PCT No.: PCT/US2022/053115

§ 371 Date: Feb. 27, 2024

Related U.S. Application Data
(60) Provisional application No. 63/292,578, filed on Dec. 22, 2021.

(51) Int. Cl. C25B 15/025; C25B 1/04; C25B 9/05; C25B 13/02

(52) U.S. Cl. CPC C25B 15/025; C25B 1/04; C25B 9/05; C25B 13/02

(57) ABSTRACT

The following disclosure relates to an electrolytic cell or system that is configured to operate with the anode or oxygen side of the cell or stack of cells at a pressure greater than atmospheric pressure. The system may include at least one electrolytic cell having a cathode, an anode, and a membrane separating the cathode and the anode. The system has an operating pressure on the cathode (hydrogen) side of the cell and an operating pressure on the anode (oxygen) side of the cell. The system is configured to operate with the operating pressure on the cathode side of the cell being greater than the operating pressure on the anode side of the cell. Further. the system is configured to operate with the operating pressure on the anode side of the cell being greater than 1 atm.

This application claims the benefit of U.S. Provisional Patent Application No. 63/292,578, filed Dec. 22, 2021, which is hereby incorporated by reference in its entirety.

### FIELD

The following disclosure relates to electrochemical or electrolysis cells and components thereof. More specifically, the following disclosure relates to electrolytic cells with operation at a pressure greater than atmospheric pressure on the oxygen side of the cell or stack.

### BACKGROUND

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive installation of electrolyzer systems.

### SUMMARY

In one embodiment, an electrolysis system is provided. The system includes at least one electrolytic cell having a cathode, an anode, and a membrane separating the cathode and the anode. The system has an operating pressure on the cathode side of the cell and an operating pressure on the anode side of the cell. The system is configured to operate with the operating pressure on the cathode side of the cell being greater than the operating pressure on the anode side of the cell, and wherein the operating pressure on the anode side of the cell is greater than 1 atm.

In another embodiment, an electrolysis system includes an electrolytic cell having a cathode, an anode, and a membrane separating the cathode and the anode, therein defining a cathode side of the cell and an anode side of the cell. The system further includes a controller configured to control a pressure differential between an operating pressure on the cathode side of the cell and control an operating pressure on the anode side of the cell such that the operating pressure on the cathode side of the cell is greater than the operating pressure on the anode side of the cell and the operating pressure on the anode side of the cell is greater than 1 atm.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrolytic cell.

FIG. 2 depicts an additional example of an electrolytic cell.

FIG. 3 depicts an example of a section of a system having an electrolytic stack.

FIGS. 4 and 5 depict examples of charts showing oxygen solubility as a function of temperature and pressure.

FIG. 6 depicts an example communication system between an electrolytic stack and a computing device having a controller over a connected network.

FIG. 7 depicts an example of a computing device having a controller.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

As used herein, the term “intermediate pressure” or “intermediate oxygen (O₂) pressure” may refer to an operating pressure of the oxygen (or anode) side of an electrolytic cell that is greater than atmospheric pressure (1 atm) and less than the operating pressure of the hydrogen (or cathode) side of the electrolytic cell. In some examples, the intermediate pressure may refer to a pressure that is at least 1.01 atm, at least 1.05 atm, at least 1.1 atm, at least 2 atm, at least 3 atm, at least 5 atm, or at least 10 atm, and less than 30 atm, less than 20 atm, or less than 10 atm. In certain examples, the intermediate pressure may refer to a pressure in a range of 1.1-30 atm, 1.1-20 atm, 1.1-10 atm, 2-30 atm, 2-20 atm, 2-10 atm, 3-30 atm, 3-20 atm, 3-10 atm, 5-30 atm, 5-20 atm, 5-10 atm, 10-30 atm, or 10-20 atm. In other examples, the intermediate pressure may refer to a pressure on the oxygen side of the electrolytic cell that is greater than atmospheric pressure, less than the operating pressure of the hydrogen side of the cell and having a certain ratio between the operating pressure of the hydrogen side of the cell to the operating pressure of the oxygen side of the cell.

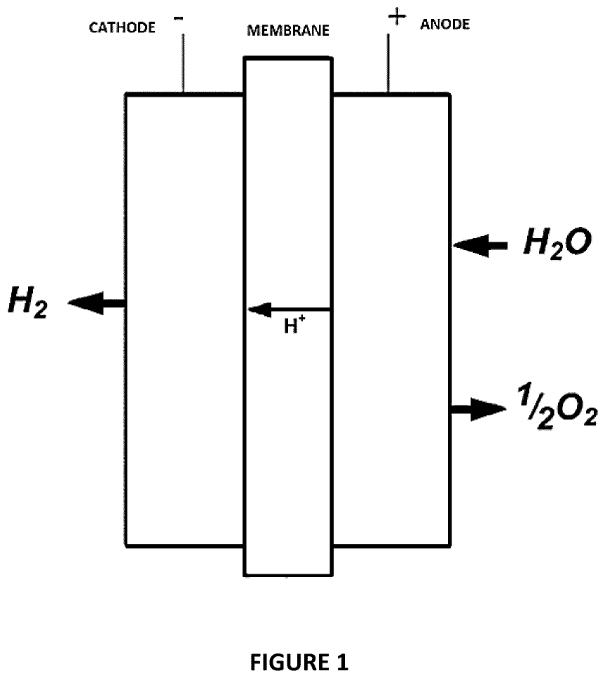

FIG. 1 depicts an example of an electrolytic cell for the production of hydrogen gas and oxygen gas through the splitting of water. The electrolytic cell includes a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.”

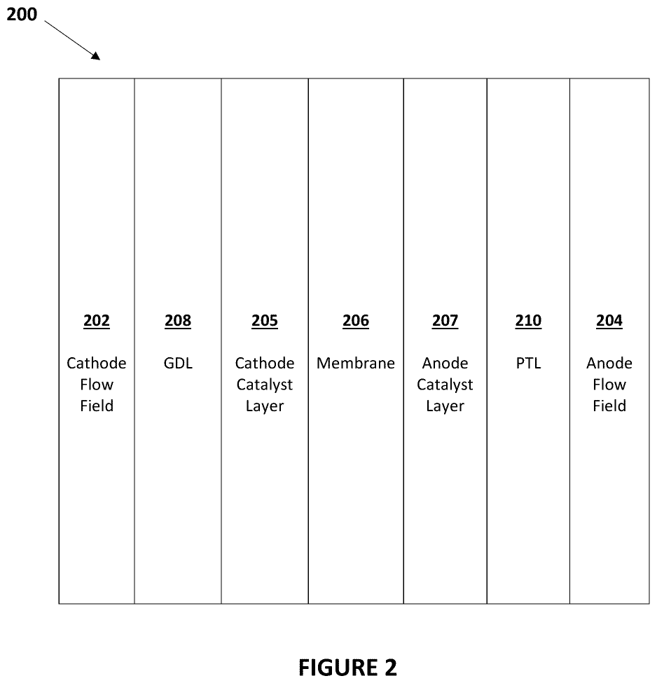

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

In certain examples, the PTL is made from a titanium (Ti) mesh/felt. As used herein, a Ti mesh/felt may refer to a structure created from microporous Ti fibers. The Ti felt structure may be sintered together by fusing some of the fibers together. Ti felt may be made by a special laying process and a special ultra-high temperature vacuum sintering process. The Ti felt may have an excellent three-dimensional network, porous structure, high porosity, large surface area, uniform pore size distribution, special pressure, and corrosion resistance, and may be rolled and processed.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

The thickness of the PTL may be within a range of 100-1000 microns, for example. The thickness may affect the mass transport within the cell as well as the durability/deformability and electrical/thermal conductivity of the PTL. In other words, a thinner PTLs compared to thicker PTLs (e.g., 1 mm) may provide better mass transport. However, when the PTL is too thin (e.g., less than 100 microns), the PTL may suffer from poor two phase flow effects as well. PTLs are less prone to deformation compared to GDLs. Thickness of PTLs may also affect lateral electron conduction resistance along the lands in between channels.

In some examples, an anode catalyst coating layer may be positioned between the anode 204 and the PTL.

The cathode 202 and anode 204 of the cell may individually include a flow field plate composed of metal, carbon, or a composite material having a set of channels machined, stamped, or etched into the plate to allow fluids to flow inward toward the membrane or out of the cell.

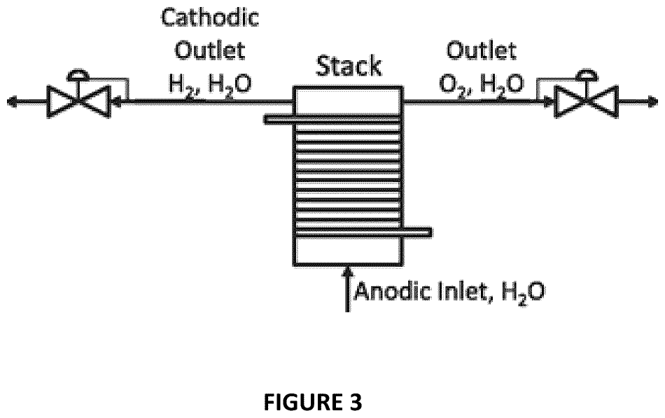

FIG. 3 depicts an example of a portion of electrolysis system for producing hydrogen gas and oxygen gas from water. The system includes a stack including a plurality of electrochemical cells. The stack is configured to receive water through an anodic inlet. The system further includes a cathodic outlet at an outlet of the stack. The cathodic outlet transfers the hydrogen gas produced from the electrolytic cells to further downstream components for further processing. In certain configurations, a water byproduct is also provided at the cathodic outlet (wherein the water may be used as a coolant for the hydrogen gas produced). Additional downstream components following the cathodic outlet are not depicted, but may include water-gas separators, purifiers, heat exchangers, circulation pumps, pressure regulators, etc. In FIG. 3, a cathodic pressure regulator is depicted at the cathodic outlet. This pressure regulator may be positioned further downstream from the cathodic outlet after one or more further components such as a water-gas separator or purifier but is depicted at the particular location in FIG. 3 for simplicity.

Further, the electrolysis system includes an anodic outlet that transfers the oxygen gas produced from the electrochemical cells within the stack as well as unreacted water byproduct to further downstream components for further processing. Again, the additional downstream components following the anodic outlet are not depicted, but may include water-gas separators, purifiers, heat exchangers, circulation pumps, pressure regulators, etc. In FIG. 3, an anodic pressure regulator is depicted at the anodic outlet. This pressure regulator may be positioned further downstream from the anodic outlet after one or more further components such as a water-gas separator or purifier but is depicted at the particular location in FIG. 3 for simplicity.

In certain examples, the electrolytic cell or electrolysis system may operate in one of two states. In one operating state, the system operates with both the hydrogen side of the cell/stack and the oxygen side of the cell/stack at an elevated pressure (e.g., greater than atmospheric pressure, such as in the range of 10-30 atm), wherein there is no pressure drop across the stack (the pressure on the hydrogen side of the stack and the pressure on the oxygen side of the stack are similar). This high-pressure environment may be advantageous in providing improved oxygen solubility over a system operating at atmospheric pressure on the oxygen side of the stack.

However, there are significant challenges with material selection and cost to provide adequate safety due to the elevated pressure. Specifically, operation at greater than atmospheric pressure on the oxygen side requires additional safety and controls. Specifically, there is an added risk of explosion if the membrane were to perforate, and hydrogen were to abruptly increase on the oxygen side. This risk is increased because an oxygen water loop within the system (not depicted in FIG. 3) is now configured to maintain high pressure, as opposed to being an atmospheric system where a rupture of the pipe could be a relatively benign water leak. In addition, in the event of rupture, there is now a risk of oxygen crossing to the hydrogen side. In a system operating at 1 atm on the oxygen side of the cell/stack, the hydrogen pressure must always be higher than the oxygen side. In an elevated-pressure oxygen system having the oxygen side of the cell/stack operating at a pressure greater than atmospheric pressure, the pressure-difference must now be actively controlled.

In an alternative operating state, the system operates at 1 atm with no compression on the oxygen side of the stack. This may be advantageous in providing a safer operating environment. However, the tradeoff is that oxygen solubility within water is lower (i.e., higher operating pressure on the oxygen side of the cell/stack provides higher oxygen solubility in water). Additionally, there are various thermal and water management difficulties with operating in an intermediate configuration with a pressure drop across the membrane, with the hydrogen side of the stack operating at high pressure and the oxygen side operating at 1 atm. For example, in a 5 MW/m³ stack running at 70% efficiency, aggregated into 500 MW scale plants, the lowest-cost solution would involve air-cooling, (e.g., passive cooling), to a 50° C. heat-bath. The O₂ pressure could be raised to a pressure greater than 1 atm. This would allow for the electrolysis temperature to be raised up from 60° C. to greater than 100° C. This could reduce the size of the heat-exchangers within the electrolysis system by a factor of 5.

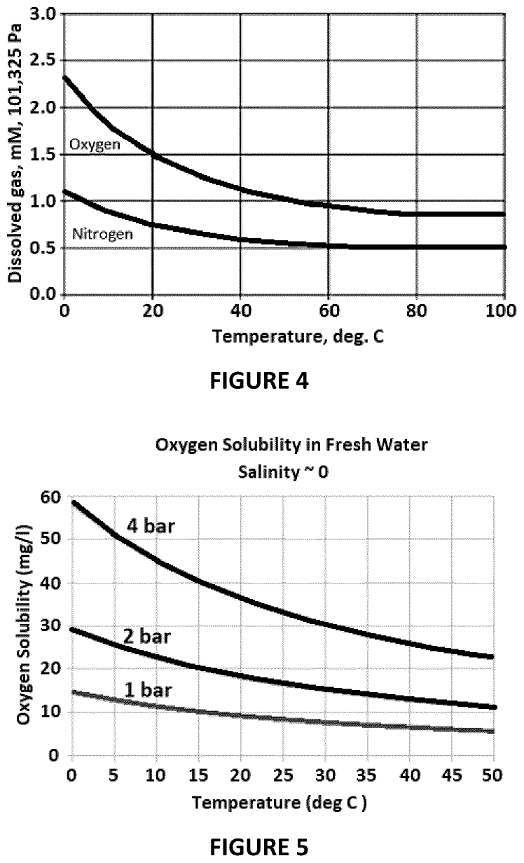

As depicted in FIGS. 4 and 5, oxygen solubility is lower at higher operating temperatures. Further, the solubility of oxygen increases steeply with an increase in pressure. For example, oxygen solubility may increase from 5 to 25 mg/l when increasing the operating pressure from 1 to 4 bar at 50° C.

With regard to the water management challenge, the O₂ is water-saturated at 1 atm and 80° C., and the gas is approximately 50% O₂/50% H₂O. For safety and regulatory reasons, the operating conditions would likely reject all O₂ directly to air. At 1 atm, this rejects a lot of water, adding to capital and/or operating expenditures in the operation of the system.

If O₂ is rejected without water separation, raising the operating pressure reduces the amount of water rejected.

Therefore, as disclosed herein, an optimal or improved solution may be to operate the cell or stack with a pressure drop across the membrane, wherein the hydrogen side of the cell/stack operates at a higher pressure than the oxygen side of the stack, and the oxygen side of the cell or stack operates at an intermediate pressure greater than atmospheric pressure but still less than the pressure on the hydrogen side of the cell/stack.

In some examples, the high pressure on the hydrogen side of the cell/stack may be at least 2 atm, at least 3 atm, at least 5 atm, at least 10 atm, at least 15 atm, at least 20 atm, at least 30 atm, in a range of 2-30 atm, in a range of 5-30 atm, in a range of 10-30 atm, in a range of 10-20 atm, in a range of 8-10 atm, etc.

In certain examples, the intermediate pressure on the oxygen side of the cell/stack is greater than atmospheric pressure and less than the high pressure on the hydrogen side of the cell/stack. In certain examples, the intermediate pressure may be at least 1.01 atm, at least 1.05 atm, at least 1.1 atm, at least 2 atm, at least 3 atm, at least 5 atm, or at least 10 atm, and less than 30 atm, less than 20 atm, or less than 10 atm. In certain examples, the intermediate pressure on the oxygen side of the cell stack is in a range of 1.1-30 atm, 1.1-20 atm, 1.1-10 atm, 2-30 atm, 2-20 atm, 2-10 atm, 3-30 atm, 3-20 atm, 3-10 atm, 5-30 atm, 5-20 atm, 5-10 atm, 10-30 atm, or 10-20 atm.

In some examples, the system is configured to operate with high pressure on the hydrogen side of the cell/stack, intermediate pressure on the oxygen side of the cell/stack, and a pressure drop from the hydrogen side of the cell/stack to the oxygen side of the cell/stack of a certain pressure amount (e.g., a pressure drop of at least 20 atm, at least 15 atm, at least 10 atm, at least 5 atm, at least 3 atm, at least 2 atm, at least 1 atm, at least 0.5 atm, at least 0.1 atm, etc.).

In other examples, the system is configured to operate with high pressure on the hydrogen side of the cell/stack and intermediate pressure on the oxygen side of the cell/stack less than the pressure on the hydrogen side of the cell/stack, wherein the pressures on the hydrogen and oxygen sides of the cell/stack are with a certain ratio of each other, (e.g., 1.1:1 to 20:1 hydrogen operating pressure:oxygen operating pressure, 1.1:1 to 10:1, 1.1:1 to 5:1, 1.1:1 to 2:1, 1.1:1 to 1.5:1, or 1.1:1 to 1.2:1).

Such an improved solution having a system with intermediate oxygen pressure as described herein may provide various operating advantages over conventional operating cells/stacks. For example, an electrolytic cell/stack system operating at an intermediate oxygen pressure may provide an improved solubility to improve the transport problem at catalytic sites, while minimizing added safety concerns for operating the oxygen side at higher than atmospheric pressure.

Furthermore, at such an intermediate pressure, this would allow for both high temperature operation and low-cost oxygen drying/rejection.

Additionally, the improved solution having a system with intermediate oxygen pressure may generate larger volumes of oxygen and/or hydrogen gas within the cells/stacks. For example, for electrolytic cell or electrolytic stack systems operating at a current density that may be at least 3 amps/cm², operation at intermediate oxygen pressure may generate a larger volume of oxygen gas and/or hydrogen gas over a similar system with the anode/oxygen side of the cell/stack operating at ambient pressure or without a pressure drop across the stack.

Another advantage of an electrolytic cell/stack system operating at an intermediate oxygen pressure is an added safety advantage for thin membranes. In certain examples, the membranes within the electrolytic cells/stack have thicknesses that are less than 1000 microns, 500 microns, 100 microns, 50 microns, 10 microns, 5 microns, 1 micron, in a range of 1-1000 microns, 5-500 microns, 10-100 microns, etc. Specifically, thin membranes between the cathode side (hydrogen side) and anode side (oxygen side) of the electrolytic cell may have a higher propensity for undesired hydrogen crossover from the cathode/hydrogen side of the cell to the anode/oxygen side of the cell. Operation of the oxygen side of the cell at an intermediate pressure may be advantageous in reducing or limiting the propensity for hydrogen crossover in comparison to a similar cell (with a similar membrane) operating the oxygen side of the cell at atmospheric pressure.

As noted above, operating the oxygen side of a stack at an intermediate pressure greater than atmospheric pressure creates added safety and control challenges. As disclosed herein, in certain examples, the stack or electrolysis system may include a system control that monitors the pressure differential and provides a vent mechanism (e.g., pressure release valve) on the oxygen side of the stack to release pressure under certain conditions. For example, the vent or pressure release valve may be opened when the oxygen pressure exceeds a threshold pressure defined by the system (e.g., when the pressure on oxygen side of the stack increases above 2 atm, 5 atm, 8 atm, 10 atm). Alternatively, the vent may be configured to be opened when the pressure differential between the oxygen and hydrogen pressure drops below a defined threshold level (e.g., when the pressure differential is less than 2 atm, 1 atm, etc.). This vent mechanism may be advantageous in preventing hydrogen crossover from the hydrogen side of the stack to the oxygen side of the stack.

In certain examples, in order to control the pressure on the oxygen side of the stack, a dual-pressure system on the oxygen side is provided where, in normal operation, water is looped, and oxygen separated at elevated pressure (e.g., 5 atm) and then immediately released to a 1 atm oxygen release system. A blow-out valve (e.g., similar to natural-gas systems) connects the two systems, so that if the pressure increases above the target set-point (e.g., 5.1 atm) the valve opens to ensure safety. In addition, the hydrogen and oxygen sides may be connected by a pressure-difference sensor (e.g., a movable diaphragm) that again will rapidly lower the pressure of the oxygen side via the blow-out valve in the event that the oxygen pressure exceeds the hydrogen pressure or comes within a certain range of the hydrogen pressure. Again, this type of control mechanism may be advantageous in preventing hydrogen crossover from the hydrogen side of the stack to the oxygen side of the stack.

In other examples, an additional system control may be provided for preventing hydrogen crossover to the oxygen side of the stack when the electrolysis system has been shut-off (i.e., in a power-down state). In conventional cells, hydrogen electrolysis projects may operate in a grid-connected mode, with the cell operating 24 hours a day and the capacity factor being near 100%. Renewable energy sources such as solar power may be intermittent, e.g., wherein the solar power is only available for 25% of the time. A desired property of a “green hydrogen” cell operating with such a solar source is that the cell maintain high lifetime during field operation even if the “capacity factor” is low (for example, if the CF is 25%, the cell may be “Off” 75% of the time).

One challenge is that hydrogen crossover to the oxygen side of the stack may increase the degradation of the cell even when the cell is powered off, through the reaction of hydrogen with the catalysts and other components of the cell. However, conventional systems may use hydrogen pressure as a primary control, e.g., the voltage on the cell is set to achieve a target hydrogen pressure (independent of the cell current). This allows for simple pressure management on the hydrogen side, but the “Off” state leads to ongoing degradation even though the cell is not operating.

A solution to this degradation problem may include a dual-mode control system that controls for pressure in the “On” state and switches to control for current in the “Off” state. For example, on ramping down, the hydrogen in this system may now be controlled to fall to 1 atm as the water continues to flush. In other words, the hydrogen side of the stack may also have a vent or pressure release valve allowing the hydrogen side to vent to atmosphere during a shutdown procedure to avoid crossover from the hydrogen side to the oxygen side during the shutdown state. The controller within the electrolysis system may be configured to control the venting of both the hydrogen side of the stack and the oxygen side of the stack during a shutdown procedure to maintain a pressure differential between the two until the stack is at or near atmospheric pressure on both sides of the stack. That is, the oxygen side may be depressured to atmospheric pressure before the hydrogen side is depressured to atmospheric pressure.

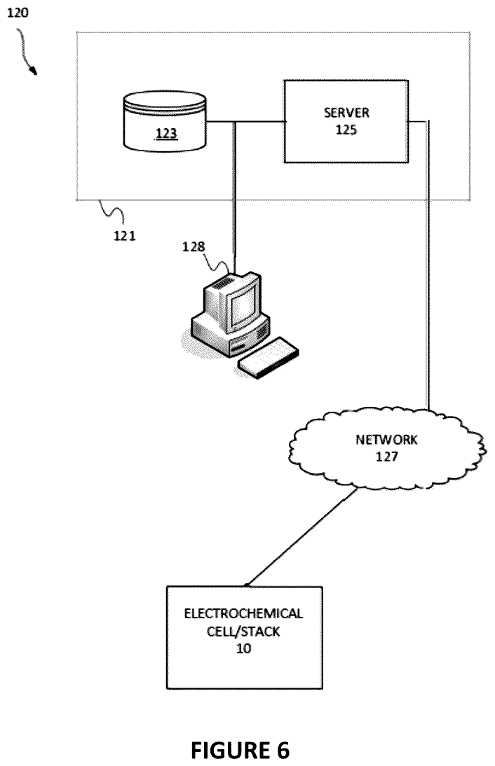

FIG. 6 illustrates an exemplary system 120 for controlling operation of an electrochemical cell or stack (e.g., including controlling the operating pressures on the cathode side and anode side of the cell or stack). The system 120 includes the electrochemical cell/stack 10, a monitoring system 121, a workstation 128, and a network 127. Additional, different, or fewer components may be provided.

The system 121 includes a server 125 and a database 123. The system 121 may include computer systems and networks of a system operator (e.g., the operator of the electrochemical cell/stack 10). The server database 123 may be configured to store information regarding the operating conditions or setpoints for optimizing the performance of the electrochemical cell/stack 10.

The developer system 121, the workstation 128, and the electrochemical cell/stack 10 are coupled with the network 127. The phrase “coupled with” is defined to mean directly connected to or indirectly connected through one or more intermediate components. Such intermediate components may include hardware and/or software-based components.

The optional workstation 128 may be a general-purpose computer including programming specialized for providing input to the server 125. For example, the workstation 128 may provide settings for the server 125. The workstation 128 may include at least a memory, a processor, and a communication interface.

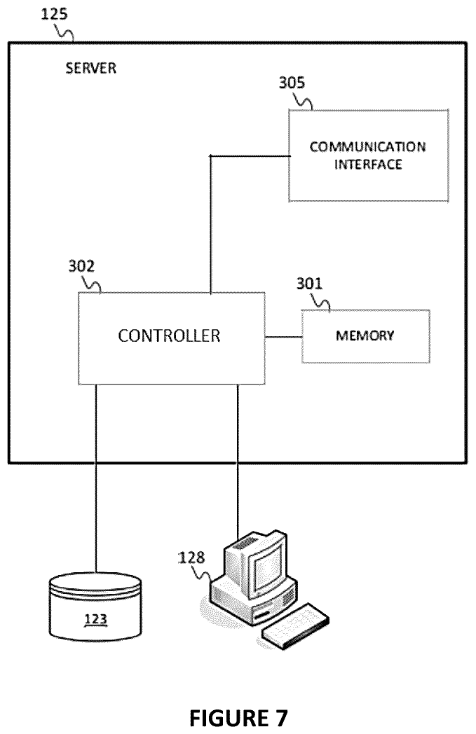

FIG. 7 illustrates an exemplary server 125 of the system of FIG. 6. The server 125 includes a memory 301, a controller or processor 302, and a communication interface 305. The server 125 may be coupled to a database 123 and a workstation 128. The workstation 128 may be used as an input device for the server 125. The communication interface 305 receives data indicative of use inputs made via the workstation 128 or a separate electronic device.

The controller or processor 302 may include a general processor, digital signal processor, an application specific integrated circuit (ASIC), field programmable gate array (FPGA), analog circuit, digital circuit, combinations thereof, or other now known or later developed processor. The controller or processor 302 may be a single device or combination of devices, such as associated with a network, distributed processing, or cloud computing.

The controller or processor 302 may also be configured to cause the electrochemical cell or stack to: (1) adjust an operating pressure of the cathode side of the cell/stack via a vent or pressure relief valve; (2) adjust an operating pressure of the anode side of the cell/stack via a vent or pressure relief valve; and/or (3) commence a shutdown procedure and control the pressure of one or both sides of the cell/stack via one or more vents/pressure relief valves.

The memory 301 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the device 122, such as a secure digital (SD) memory card.

The communication interface 305 may include any operable connection. An operable connection may be one in which signals, physical communications, and/or logical communications may be sent and/or received. An operable connection may include a physical interface, an electrical interface, and/or a data interface. The communication interface 305 provides for wireless and/or wired communications in any now known or later developed format.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. An electrolysis system comprising:
an electrolytic cell having a cathode, an anode, and a membrane separating the cathode and the anode, therein defining a cathode side of the electrolytic cell and an anode side of the electrolytic cell,
wherein the system has an operating pressure on the cathode side of the electrolytic cell and an operating pressure on the anode side of the electrolytic cell,
wherein the system is configured to operate with the operating pressure on the cathode side of the electrolytic cell being greater than the operating pressure on the anode side of the electrolytic cell, therein defining a pressure differential between the cathode side of the electrolytic cell and the anode side of the electrolytic cell,
wherein the pressure differential is greater than 20 atm, and
wherein the operating pressure on the anode side of the electrolytic cell is greater than 1 atm.

2. The system of claim 1, wherein the operating pressure on the cathode side of the electrolytic cell is at least 30 atm.

3. The system of claim 2, wherein the operating pressure on the anode side of the electrolytic cell is in a range of 1.1-20 atm.

4. The system of claim 1, wherein the operating pressure on the anode side of the electrolytic cell is in a range of 1.1-20 atm.

5.-6. (canceled)

7. The system of claim 1, wherein the system is configured to generate a larger volume of oxygen gas on the anode side of the electrolytic cell and/or a larger volume of hydrogen gas on the cathode side of the electrolytic cell in comparison to a similar system with an operating pressure of 1 atm on the anode side of the electrolytic cell.

8. The system of claim 7, wherein the system is configured to generate the larger volume of oxygen gas and/or the larger volume of hydrogen gas with the electrolytic cell of the system operating at a current density of at least 3 amps/cm².

9. The system of claim 1, wherein a thickness of the membrane of the electrolytic cell is in a range of 1-1000 microns.

10. The system of claim 9, wherein the system is configured to have a reduced propensity for hydrogen crossover in comparison to a similar system with an operating pressure of 1 atm on the anode side of the electrolytic cell.

11. The system of claim 1, further comprising:
a vent or pressure release valve on the anode side of the electrolytic cell configured to open when the operating pressure on the anode side of the electrolytic cell exceeds a threshold value or when a pressure differential between the cathode side and the anode side drops below a threshold amount.

12. The system of claim 11, further comprising:
a vent or pressure release valve on the cathode side of the electrolytic cell configured to open during a shutdown procedure of the system.

13. The system of claim 12, further comprising:
a controller configured to control a venting of hydrogen on the cathode side of the electrolytic cell through the vent or pressure release valve on the cathode side of the electrolytic cell and control a venting of oxygen on the anode side of the electrolytic cell through the vent or pressure release valve on the anode side of the electrolytic cell,
wherein the controller is further configured to maintain a pressure differential between the cathode side of the electrolytic cell and the anode side of the electrolytic cell during the shutdown procedure such that the pressure on the cathode side of the electrolytic cell remains higher than the pressure on the anode side of the electrolytic cell until both sides of the electrolytic cell are at atmospheric pressure.

14. The system of claim 1, further comprising:
a vent or pressure release valve on the cathode side of the electrolytic cell configured to open during a shutdown procedure of the system.

15. The system of claim 14, further comprising:
a controller configured to control a venting of hydrogen on the cathode side of the electrolytic cell during the shutdown procedure of the system through the vent or pressure release valve on the cathode side of the electrolytic cell.

16. An electrolysis system comprising:
an electrolytic cell having a cathode, an anode, and a membrane separating the cathode and the anode, therein defining a cathode side of the electrolytic cell and an anode side of the electrolytic cell; and
a controller configured to control a pressure differential between an operating pressure on the cathode side of the electrolytic cell and an operating pressure on the anode side of the electrolytic cell such that the operating pressure on the cathode side of the electrolytic cell is greater than the operating pressure on the anode side of the electrolytic cell and the operating pressure on the anode side of the electrolytic cell is greater than 1 atm,
wherein the pressure differential is greater than 20 atm.

17. The system of claim 16, further comprising:
a vent or pressure release valve on the cathode side of the electrolytic cell configured to open to vent hydrogen and reduce pressure on the cathode side of the electrolytic cell.

18. The system of claim 17, wherein the controller is configured to control a venting of the hydrogen on the cathode side of the electrolytic cell during a shutdown procedure of the system through the vent or pressure release valve on the cathode side of the electrolytic cell.

19. The system of claim 18, wherein the controller is further configured to maintain the pressure differential between the cathode side of the electrolytic cell and the anode side of the electrolytic cell during the shutdown procedure such that the pressure on the cathode side of the electrolytic cell remains higher than the pressure on the anode side of the electrolytic cell until both sides of the electrolytic cell are at atmospheric pressure.

20. The system of claim 16, further comprising:
a vent or pressure release valve on the anode side of the electrolytic cell configured to open to vent oxygen and reduce pressure on the anode side of the electrolytic cell.

21. The system of claim 20, wherein the controller is configured to open the vent or pressure release valve on the anode side of the electrolytic cell to vent the oxygen and reduce the pressure on the anode side of the electrolytic cell when the operating pressure on the anode side of the electrolytic cell exceeds a threshold value or when a pressure differential between the operating pressure on the cathode side and the operating pressure on the anode side drops below a threshold amount.

22. The system of claim 16, wherein the operating pressure on the anode side of the electrolytic cell is in a range of 1.1-20 atm.
